(19) United States
(12) Patent Application Publication
(10) Pub. No.: US 2026/0253128 A1
(43) Pub. Date: Aug. 27, 2026

(54) INFRASTRUCTURE IMPLEMENTATION OF AN ENDLESS AISLE USEFUL FOR BUSINESS TRANSFORMATION

(71) Applicant: Dell Products L.P., Round Rock, TX (US)

(72) Inventors: Michael Robillard, Shrewsbury, MA (US); Karim Elghamry, Co. Cork (IE); Ramona Devi, San Jose, CA (US); Xuebin He, Westwood, MA (US); Yichun Xu, Everett, MA (US); Rushiv Arora, Boston, MA (US)

(21) Appl. No.: 19/066,019

(22) Filed: Feb. 27, 2025

(51) Int. Cl. G06Q 30/0601; G01S 13/88; G06Q 10/087; G06V 40/18; G06V 40/20

(52) U.S. Cl. CPC G06Q 30/0635; G01S 13/88; G06Q 10/087; G06V 40/18; G06V 40/28

(57) ABSTRACT

One example method is a method for a virtual shopping experience. The method includes connecting an app on a mobile device of a customer to a store hub associated with a virtual endless aisle, in response to an interaction of the customer with a product, emitting, by a smart shelf of the virtual endless aisle, an event, based on the event, transmitting, by the store hub to a display screen visible to the user, information concerning the product, displaying, by the display screen, a portion of the virtual endless aisle that includes the information concerning the product, detecting, by a camera associated with the virtual endless aisle, a product selection signal generated by the customer, and enabling, by the virtual endless aisle, the customer to purchase the product.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to the implementation and use of virtual environments. More particularly, at least some embodiments relate to systems, hardware, software, computer-readable media, and methods, for implementing and using an endless aisle.

### BACKGROUND

After the global pandemic changed the way people shop, customers started expecting a lot more from retailers. Many consumers prefer to buy in-store. A significant issue when shopping in-store, however, is the low stock of products that commonly occurs. Due to finite space requirements, retailers need to have a smaller stock of products compared to e-commerce retailers.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses an approach for Identifying a human and placing that human within a physical store, according to one embodiment.

FIG. 2 discloses an approach for identifying a particular customer using RF range finding, according to one embodiment.

FIG. 3 discloses an approach for converting ranging information into physical coordinates, according to one embodiment.

FIG. 4 discloses how an identified customer selects products of interest, according to one embodiment.

FIG. 5 discloses how an identified customer interacts with virtual merchandise, according to one embodiment.

FIG. 6 discloses how an identified customer triggers a commercial transaction, according to one embodiment.

FIG. 7 discloses an example mobile application for facilitating a commercial transaction, according to one embodiment.

FIG. 8 discloses an example interaction between mobile, customer visible, and back end components, according to one embodiment.

FIG. 9 discloses aspects of an example computing entity configured and operable to perform any of the disclosed methods, processes, and operations.

### DETAILED DESCRIPTION OF SOME EXAMPLE EMBODIMENTS

Embodiments disclosed herein generally relate to the implementation and use of virtual environments. More particularly, at least some embodiments relate to systems, hardware, software, computer-readable media, and methods, for implementing and using an endless aisle. An embodiment may, or may not, be implemented in a commercial environment.

One or more example embodiments may be implemented in a commercial environment, such as a retail context for example. However, the scope of this disclosure is not limited to that example implementation and application. More generally, this disclosure embraces any context in which a human, present in a physical environment, is able to use a virtual aisle or other virtual ‘structure’ to select one or more physical items and/or services, whether for purchase, or otherwise. For example, an embodiment may be employed by a worker who is checking out tools and equipment to be used by the worker to perform a task.

In one embodiment, applied in a retail context, a method may be performed by a customer in conjunction with a commercial entity. Such a method may comprise operations including, but not limited to: a customer opens a mobile app on his phone which receives ranging information and connects to a store hub; the customer selects a product presented on a display screen visible to the customer, and a smart shelf of an endless aisle emits a corresponding event; the store hub gathers the latest information concerning the product and transmits that information to the display screen—for example, a first display screen 1 shows all same model designs with stock availability, a second display screen 2 shows detailed information about picked shoe, and a third display screen 3 displays a commercial video about the selected product; the customer uses a gesture directed to one of the display screens to select a desired design-a gesture-based algorithm maps the relative hand to the cursor on screen regardless of the actual location of the customer; the second display screen 2 shows ‘try on’ effects that indicates how the product appears when being worn; the customer selects-on the mobile app or on one of the display screens ‘add-to-cart’ button such as with a pinch motion; the display screen 3 and mobile application display checkout information; and, the customer checks out on the mobile application.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a productive in-store shopping experience can be provided to a user even if the associated retail entity has no/low in-store stock of the product that the user would like to purchase. An embodiment may reduce the amount of inventory needed to be stocked in a retail store, and may accordingly also reduce the costs associated with storing inventory. As well, an embodiment may reduce the costs associated with shipping the product to the retail store. An embodiment may create an environment which appears, from a user perspective, to have every item that is represented for sale in a store-where the user is located-in-stock, and which enables a user to purchase any of the items. Various other advantages of one or more embodiments will be apparent from this disclosure.

### A. Context for One or More Embodiments for One Embodiment

The following is a discussion of aspects of a context for various embodiments. This discussion is not intended to limit the scope of the claims or this disclosure, or the applicability of the embodiments, in any way.

### A.1 Introduction

The retail industry is undergoing a profound transformation driven by rapidly changing consumer preferences, technological advancements, and increasing competition. To remain relevant and competitive in this dynamic landscape, retail enterprises face the challenge of finding innovative ways to engage customers, reduce transactional friction, enhance their shopping experiences, build their brands, and drive business transformation.

This disclosure encompasses a variety of areas. These include, but are not necessarily limited to: product visualization, virtual try-on, store optimization, consumer privacy, and interactive kiosks. By leveraging these technologies, retailers can cater to the increasing demands of tech-savvy consumers who seek convenient, immersive, and informative shopping encounters. As discussed in detail elsewhere herein, some particular embodiments concern the calibration of 2+ beacon and camera systems to obtain an exact, rather than relative, location of a user, and the utilization of dynamic calibration among the systems to reduce cost.

One or more embodiments may involve what are sometimes referred to as data network effects. For example, processes, infrastructure, and algorithms may be used to generate data network effects. A data network effect refers to the situation where the value of a system increases as more data accumulates within it. Realistic creation of data network effects may be attained by automatically capturing and processing contextualized. Data network effects are commonly leveraged in generative AI systems.

Generative AI requires large datasets that must be kept fresh through back-and-forth customer interactions, such as with a virtual assistant for example. To remain competitive, an AI operator must corral data, analyze it, offer predictions, and then seek feedback, such as from one or more users, to sharpen subsequent suggestions. The value of generative AI systems depends on the data that is automatically collected from users. The generative AI system performance—its ability to accurately predict and suggest—thus hinges on the economic principle referred to as data network effects.

Useful bits of data, such as may be generated and employed in a generative AI system, can be found everywhere. As an example, data may come from interactions with buyers, suppliers, and coworkers. A retailer, for example, could track what consumers looked at, what they placed in their cart, and what they ultimately paid for. These minute, seemingly trivial, details can vastly improve the predictions of a generative AI system. This data need not necessarily be sourced from humans pounding keyboards. Such data may, instead, be sensed and gathered using devices and sensors such as microphones, cameras, and other high-resolution sensors, and processed using “Distributed ML” or “Field AI” on tailored infrastructure.

### A.2 Example Aspects of Various Embodiments

It is expected that immersive technology will become a key enabler of business transformation because it enables humans to interact with business information persisted in datastores, machinery represented as digital twins, and artificial intelligence easily and as equals. This idea may be referred to as the immersive enterprise. This disclosure defines an immersive enterprise as a business that leverages immersive technology to perform business transformation. This idea is aligned with what some in the industry define as spatial computing.

Within spatial or immersive environments, other ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. Detailed Discussion of Aspects of One or More Embodiments

### B.1 Introduction

One or more embodiments comprise methods and architectures for implementing endless aisle retail strategies that may help bridge the gaps between online and brick-and-mortar experiences. This disclosure showcases how high-end retailers might leverage novel infrastructure to implement this strategy and trade off inventory versus brand specific experiences in limited space.

Endless aisle is a retail strategy that gives a retailer the ability to sell out-of-stock items to in-store customers or to sell online items that are not kept in local inventory. To sell out-of-stock items to in-store customers, retailers place an order for inventory kept by external suppliers. The supplier then ships the product directly to the customer from their own inventory. This process, and the external supplier, is invisible to the end retail customer. It appears, to the customer, that the retailer has an endless or aisle, of products and are never truly out-of-stock. Importantly, this strategy can also be used to sell items that are not in local inventory but are available in retailer managed distribution centers.

It is estimated that retailers are missing out on nearly $1 trillion in in-store sales because they do not have on hand what their customers want to buy. When retail customers cannot find what they want locally, they may be quick to use their smartphone to shop online or with a competitor. There are any number of reasons why retailer shelves might be empty, including poor communication between vendors and retailers. alternatively, a retailer might value using their finite floor space to create a focus on brand and a unique customer experience as opposed to carrying high levels of inventory locally.

To create endless aisles, which may always be stocked, an infrastructure and associated architecture according to one or more embodiments may be used by a retailer to ensure that either their shelves stay stocked, or that the shelves visually appear to have an endless aisle of products consumers are looking for. Endless aisle strategies may require a significant investment in technology and infrastructure to manage inventory, logistics, and customer data effectively. Examples of such technology include an e-commerce platform that supports endless aisles, robust inventory management systems, shipping and fulfillment capabilities, customer data analytics tools, and their supporting infrastructure. Endless aisle strategies may also require investment in the infrastructure according to various embodiments disclosed herein.

By way of comparison with one or more embodiments, Amazon, Walmart, and others have performed research, developed intellectual property, and products in this space. Examples include: Amazon Just Walk Out, Amazon Smart Grocery Carts, Walmart Smart Check Out, and the Walmart Intelligent Retail Lab. However, while there may be some gross similarities between that work and one or more embodiments, one or more of such embodiment is differentiated on various bases such as, for example, the use in an embodiment of cellphone-based radio telemetry in combination with photonic camera data. In addition, the sensing, edge-based compute, and novel use of gesture-controlled display technology, creates differentiation between one or more embodiments, and conventional approaches.

### B.2 Detailed Discussion

### B.2.1 Overview

One or more embodiments may have various capabilities, although no embodiment is required to have any particular capability, or capabilities. For example, one or more embodiments enable the creation and use of a virtual ‘endless aisle’ by using stereoscopic cameras, smart shelves, AI models, procedural code, ultra-wide band radio beacons, smartphone applications, and computer displays. Some example capabilities of one or more embodiments include, but are not limited to:
1. [PROCESS, INFRA, ALGO FLOW] The ability to generate data network effects for the purpose of improving the performance of a generative AI system.
2. [PROCESS, INFRA, ALGO FLOW] This data will be captured without human intervention.
3. [PROCESS, INFRA, ALGO FLOW] The ability of a system to recognize a human being and place that human being inside a physical space.
4. [PROCESS, INFRA, ALGO FLOW] The ability to, securely and unobtrusively, identify a human being as a customer using packets transmitted information on a mobile application as well as place the customer inside a physical space.
5. [PROCESS, INFRA, ALGO FLOW] The ability to correlate the identified customer with a human avatar (generated in step 1. above) by combining data and information from multiple sensors.
6. [PROCESS, INFRA, ALGO FLOW] The ability to enable an identified customer to pick up merchandise from a smart shelf so that such action triggers one or more display screens to showcase sizes, price, availability, colorways, or other information relevant to a product and/or transaction.
7. [PROCESS, INFRA, ALGO FLOW] The ability to enable an identified customer to browse and select virtual merchandise while holding physical merchandise.
8. [PROCESS, INFRA, ALGO FLOW] The ability to enable an identified customer to virtually procure physical merchandise without having to submit credit card information or provide any addressing information at the time of purchase.
9. [PROCESS, INFRA, ALGO FLOW] The ability to perform all the activities of steps 1. through 8. (above), using local computation devices, radio positioning systems, cameras, and computer displays, without requiring the user to touch anything other than the mobile phone of the user, and the merchandise under consideration. In some embodiments, the user may not even touch the physical merchandise.

### B.2.2 Architectures and Operations According to Some Example Embodiments

Further details are now provided concerning some example architectures and operations according to one or more embodiments. Such architectures and operations may involve the use of various cameras, displays or screens, and computing systems. Some examples of such architectures and operations are disclosed in United States Patent Application, Ser. XX/YY, YYY, YYY, atty. docket 16192.1160, entitled SYSTEM CONTROL IDENTIFICATION WITH GAZE TRACKING, which is incorporated herein in its entirety by this reference.

A system according to one embodiment may comprise a centralized compute space, a distributed compute space, range finding beacons capable of sending/receiving packets with connected devices, touchless displays with 3D cameras, a smartphone, and back-end servers. User locations in a physical space, such as a store for example, may be determined using range finding beacons and monitoring cameras. When a person enters into the physical space, images and/or video of that person will be obtained by the camera and the person identified as a human. When a human carrying a mobile phone with an application enter the physical space, their phone connects to the UWB (ultrawideband) beacons which then identify that human to a centralized compute node with a customer number as well as ranging information. Employees may identified in the same way.

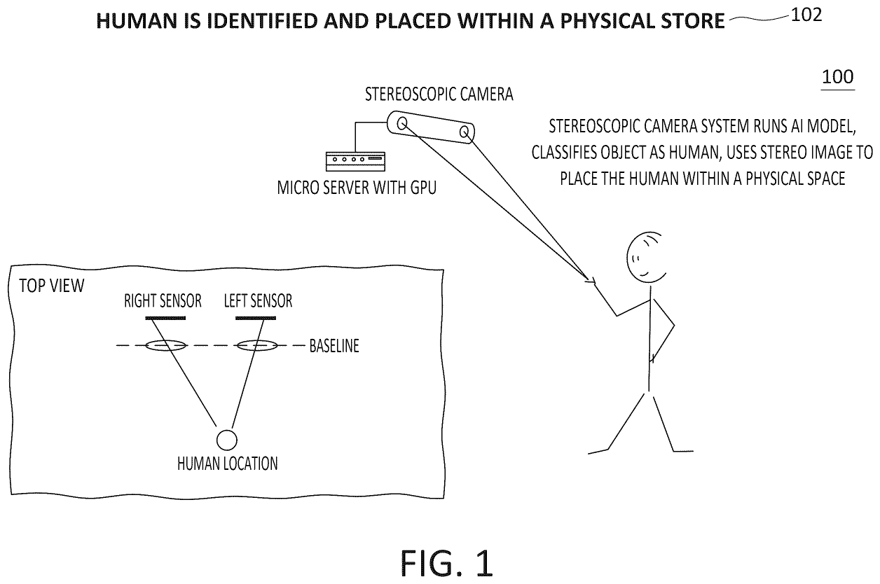

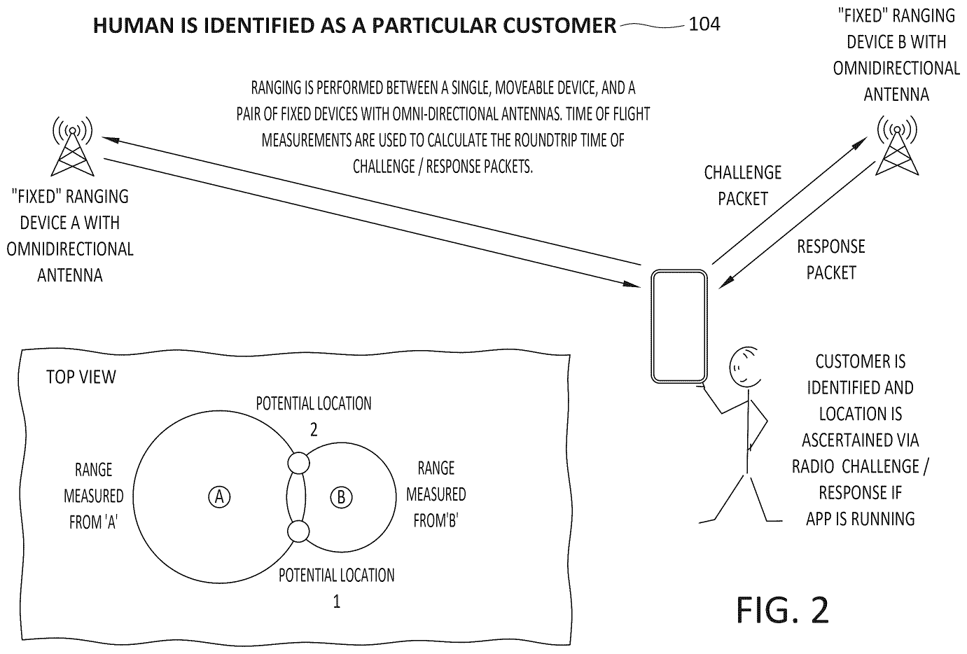

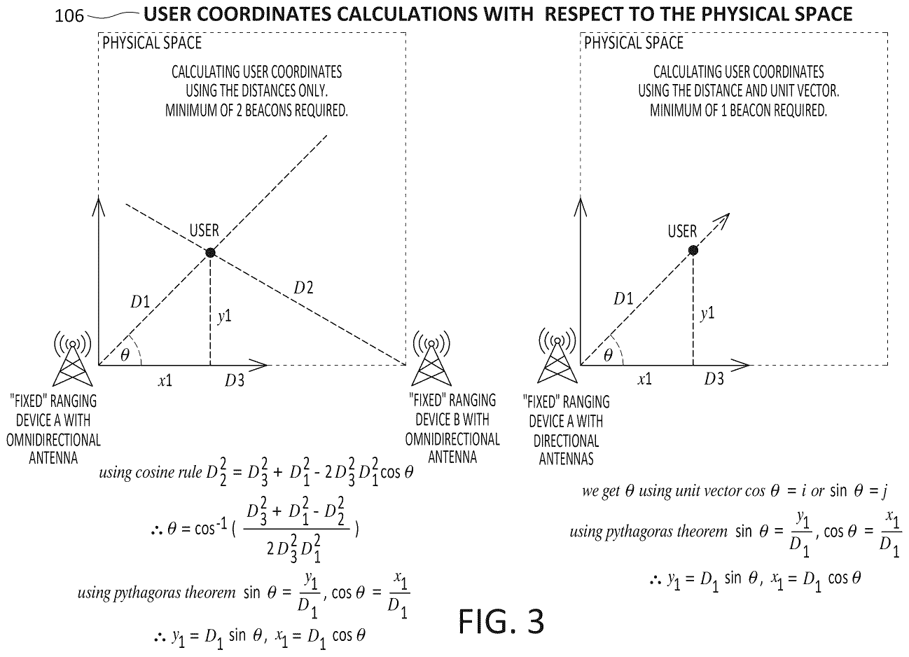

Following is a brief description of some operations of one example embodiment. These operations are presented only by way of example and are not intended to limit the scope of this disclosure, or of any claims, in any way. The operations, which may be performed after [1] the user is identified as a human and is placed within a physical location (see, e.g., FIG. 1), [2] the user is identified (see, e.g., FIG. 2), and [3] the location of the user in the physical space is determined (see, e.g., FIG. 3), may include-in an illustrative example involving shoes:
1. Customers open App on mobile device, receive ranging information, connect to Store Hub
2. Customer picks up one shoe, smart shelf emits event
3. Store Hub gather latest product stock info send to Screens
4. Screen 1 shows all same model designs with stock availability
5. Screen 2 shows details information about picked shoe
6. Screen 3 shows commercial video about picked shoe
7. Customer uses gesture to select desired design
8. The gesture-based algorithms map the relative hand to the cursor on screen regardless of the actual location
9. Screen 2 shows try on effects
10. Customer clicks add-to-cart button with pinch
11. Screen 3 and mobile application shows checkout info
12. Customer checkout on mobile application

### B.2.3 Aspects of an Example Virtual Endless Aisle

As disclosed in the examples of FIGS. 1 through 6, an embodiment may comprise a method, such as the method 100, that may implement a so-called ‘endless aisle’ that may be accessed by a user. The endless aisle may be configured at least in part based on user-specific attributes and, in this way, an endless aisle may be built and implemented to suit a particular user.

As shown in FIG. 1, the method 100 may begin 102 with the identification of an object as a human, and determining a location of that human within a particular environment, such as a retail store for example. At 104, shown in FIG. 2, the human may be identified 104 as being a particular customer. In an embodiment, this identification may use an RF (radio frequency) rangefinding process, based on signals from a mobile device, such as a cell phone, of the user to identify the user. Details concerning an example rangefinding process are indicated in FIG. 2.

It is noted, that in the process shown in FIG. 1, a user may, but need not, be identified as being a specific person. With privacy concerns in view however, an embodiment may obtain information from the cell phone that is not personal identifying information (PII), so that the privacy of the user is preserved. Any other approach for uniquely identifying the customer, but without accessing or using PII, may be employed in an embodiment.

As shown in FIG. 3, a process 106 may be performed to determine the coordinates of the location of the user within a physical space, such as the retail store mentioned earlier. In an embodiment, determining 106 the location of the user may involve converting ranging information, possibly obtained with antennas as shown in FIG. 1, into physical coordinates of the user location in the physical space.

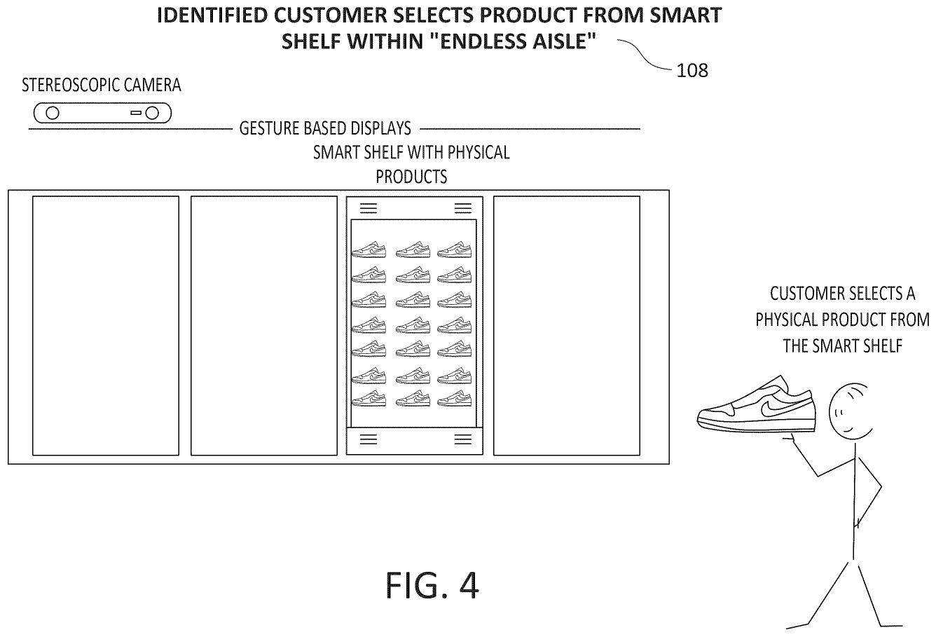

Within the physical space, as with reference now to FIG. 4, the user may select 108 one or more products from a smart shelf of an endless aisle. In particular, the physical space in which the user is located may include one or more screens and cameras, example arrangements of which are disclosed elsewhere herein. A camera may determine which of the screens the user is looking at, and may enable user control of that display. The user may then use a gesture, such as a hand movement for example, to select one or more products appearing on the display that the user is looking at.

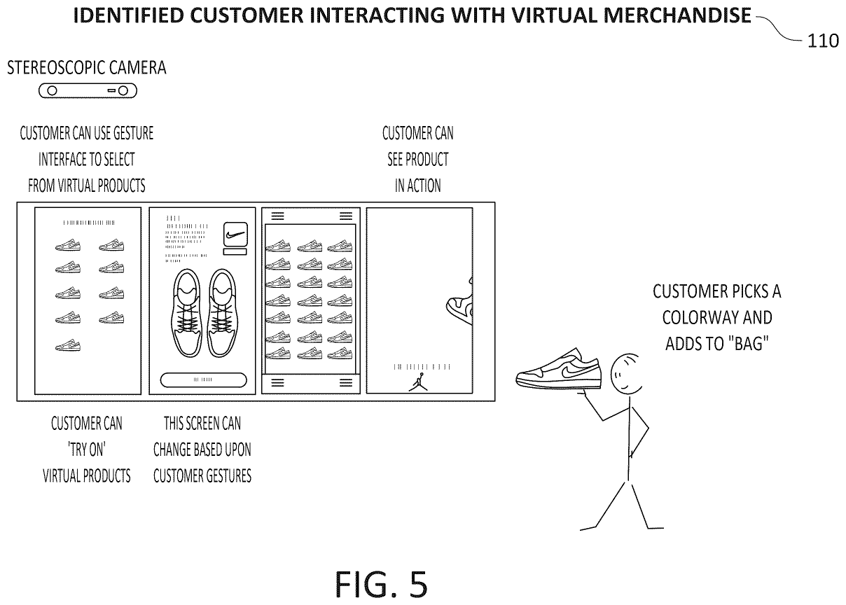

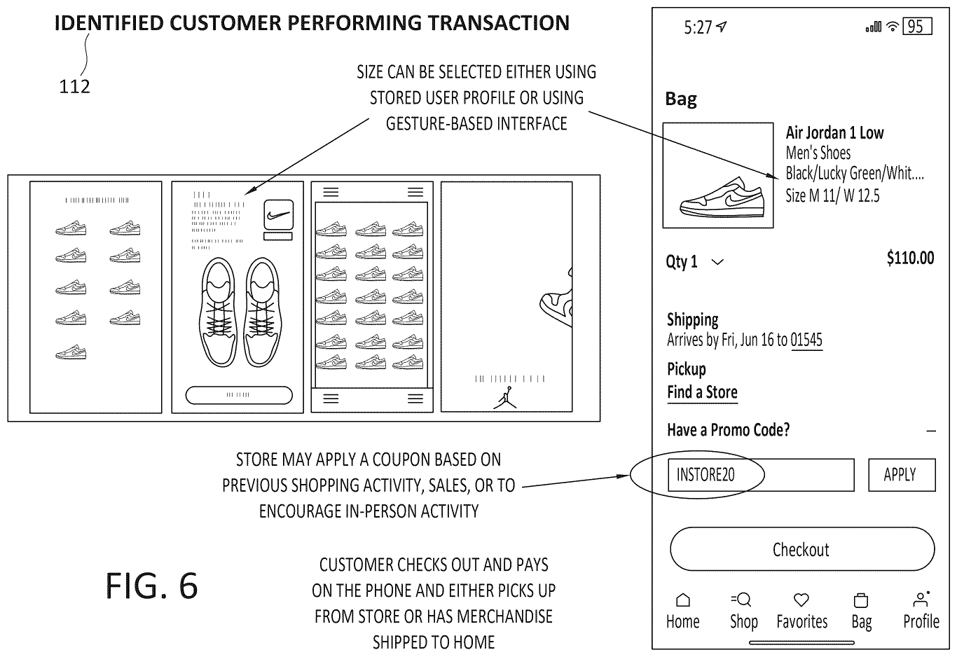

As shown in FIG. 5, the user may then interact 110 with a selected product. For example, a user can ‘try on’ a virtual product to check fit and appearance. As well, a user may be able to view a video showing the selected product in use. If the user decides to purchase a product, the user can then add the product, along with size and color information for example, to a virtual shopping bag. Finally, and as shown in FIG. 6, the user can purchase 112 the product(s) in the virtual shopping bag. The user may receive an order confirmation and shipping information.

All of the operations in FIGS. 4, 5, and 6, may be instantiated by a user simply through the use of hand, or other, gestures to control the operation of the display and the operation of an underlying computer system. The endless aisle concept disclosed herein may enable a user in a single particular location to access a wide array of products and services spanning all types of technologies and uses. It will thus be appreciated that the examples disclosed herein are presented simply for illustrative purposes, and not by way of limitation in any way.

### C. Aspects of a Virtual Endless Aisle Involving a Mobile App

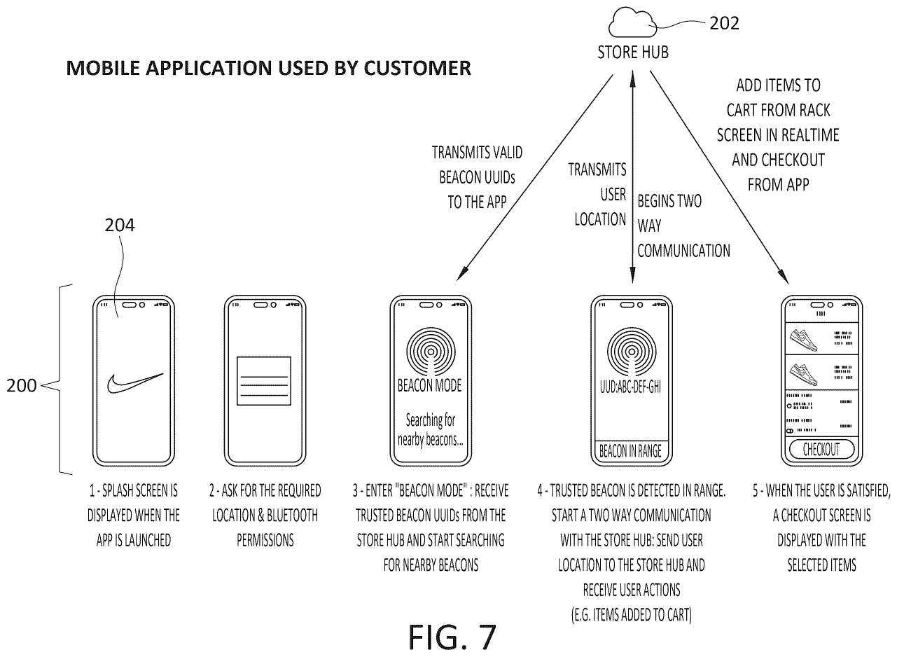

With reference now to FIG. 7, there is disclosed a method 200, according to one embodiment, for use of a mobile application to facilitate a commercial transaction involving a virtual endless aisle. As shown, the method 200 may be implemented in conjunction with a store hub 202 that communicates with a mobile app 204 on a mobile device of a user.

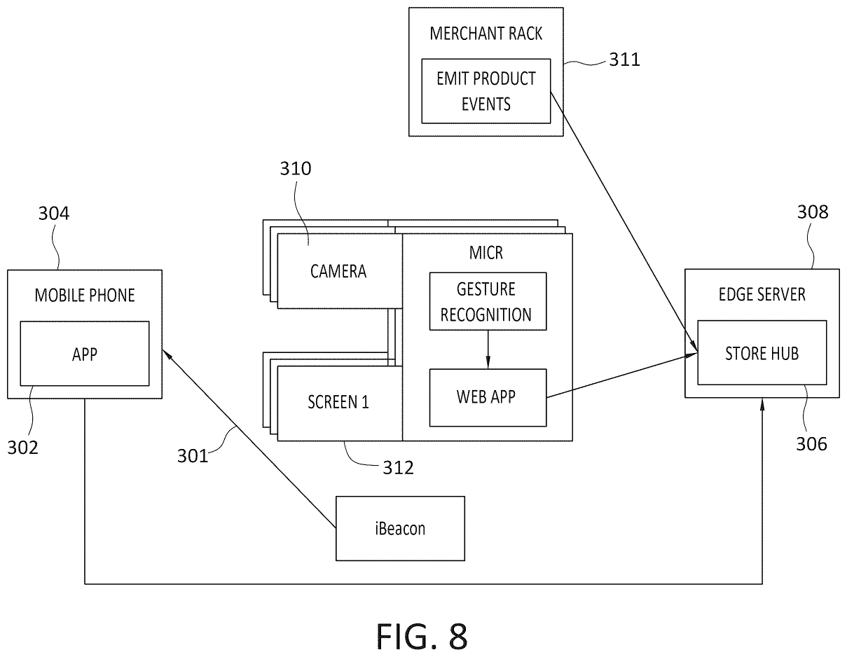

With reference now to the example of FIG. 8, an example method 300 is disclosed that involves interaction between a mobile device, customer, and back end components. In the example method 300, a customer may open an app 302 on a mobile device 304 and may automatically receive an iBeacon 301 signal that is used by the mobile device 304 to connect 303 to a store hub 306 that may be hosted on an edge server 308. The customer may be observed by a camera 310 picking up a product such as a shoe, and the camera 310 may pass this information to the store hub 306. As well, the merchant rack 311 may receive this information from the camera 310 and emit a product event.

The store hub 306 may then gather all the latest information concerning the product, and may send that info to a set of screens 312. In this example embodiment, there may be three screens 312, namely, screen 1, screen 2, and screen 3. Here, screen 1 may display all of the same model designs, including stock availability information. Screen 2 may display detailed information about the shoe selected by the customer. And screen 3may show a commercial video featuring the selected shoe.

The customer may then use a gesture, directed at screen 1 for example, to select a desired shoe design. The customer may then use a gesture to control screen 2, for example, to activate a ‘try on’ feature to see what the shoe would look like when worn. If the customer is satisfied, the customer may select, using a gesture directed to screen 3 for example, an ‘add-to-cart’ button to add the selected shoe to the customer shopping cart. Check out information may be shown on screen 3, and on the app 302. Finally, the customer may check out using the app 302.

### D. Aspects of Some Example Use Cases

Embodiments may be employed in a variety of different applications. The following examples are provided only by way of illustration and are not intended to limit the scope of this disclosure, or of any claims, in any way.

### D.1 Example 1‘—Frictionless’ Retail Display

One example embodiment may be used to power a customer monitoring and retail display system. Such a system may be used, for example, to complete touch free, secure transactions for branded merchandise like sneakers, handbags, backpacks, or other physical items that offer multiple sizes, colorways, or options where those sizes, colorways, and options create physical stocking issues. For example, with so many possible options, a retailer may not find it practical, or cost effective, to physically stock all of them in the retail store where users shop for those products.

### D.2 Example 2—Human Identification System for Public or Private Spaces

One embodiment may be used to identify humans in a non-intrusive way. For example, customers may load an application on their mobile phone while accepting some reasonable terms and conditions concerning the handling of their PII (personally identifiable information) and other confidential customer-specific information. Employees may load the application or carry an identifying beacon for similar purposes.

An embodiment of the system operates to correlate the location of the mobile phone with visual data, thereby identifying the human for circumstances including:
in the event the human needs to be identified for a medical reason, for security reasons, needs to be identified for a commercial transaction, or needs to be identified for physical access;
in the event that a customer needs to be identified to enable them access to certain high value merchandise-for example, to unlock a display case or a vault;
in the event that a human needs to be identified for an employment reason-for example, is there an employee who is not currently interacting with a customer that can be dispatched for customer service; and
in the event that a human needs to be identified to unlock access to machinery-for example, an employee accessing a table saw or milling machine- or, conversely, to disable access to machinery,

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method for a virtual shopping experience, comprising: connecting an app on a mobile device of a customer to a store hub associated with a virtual endless aisle; in response to an interaction of the customer with a product, emitting, by a smart shelf of the virtual endless aisle, an event; based on the event, transmitting, by the store hub to a display screen visible to the user, information concerning the product; displaying, by the display screen, a portion of the virtual endless aisle that includes the information concerning the product; detecting, by a camera associated with the virtual endless aisle, a product selection signal generated by the customer; and enabling, by the virtual endless aisle, the customer to purchase the product.

Embodiment 2. The method as recited in any preceding embodiment, wherein the product selection signal comprises a gesture by the customer that is detected by the camera.

Embodiment 3. The method as recited in any preceding embodiment, wherein the interaction is physical.

Embodiment 4. The method as recited in any preceding embodiment, wherein the interaction is virtual.

Embodiment 5. The method as recited in any preceding embodiment, wherein the display screen is one of a group of display screens visible to the customer, and the displaying of the information on the display screen is based on detection of a pupil of an eye of the customer.

Embodiment 6. The method as recited in any preceding embodiment, wherein a presence, and a location, of the customer in a physical space associated with the virtual endless aisle are determined using the camera and a radio beacon.

Embodiment 7. The method as recited in embodiment 6, wherein the radio beacon determines the location of the customer based on a signal received from the mobile device of the customer.

Embodiment 8. The method as recited in any preceding embodiment, wherein the enabling of the customer to purchase the product comprises presenting an ‘add to cart’ option to the customer on the app, providing checkout information to the customer by way of the app, and enabling the customer to checkout with the app.

Embodiment 9. The method as recited in any preceding embodiment, wherein the information concerning the product comprises model designs and stock availability, and/or a video.

Embodiment 10. The method as recited in any preceding embodiment, wherein after the interaction, a ‘try on’ option is presented to the user on the display screen.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

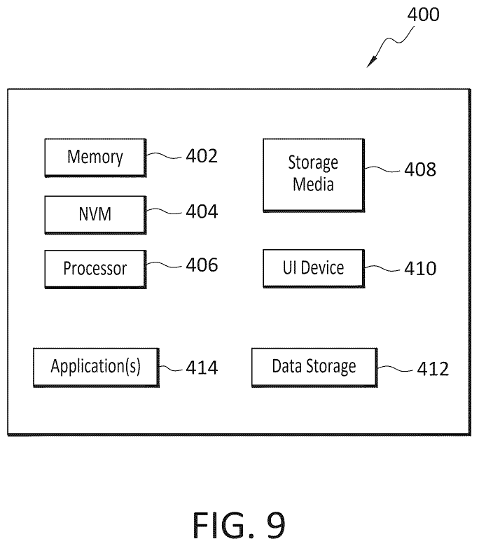

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 9.

In the example of FIG. 9, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for a virtual shopping experience, comprising:
connecting an app on a mobile device of a customer to a store hub associated with a virtual endless aisle;
in response to an interaction of the customer with a product, emitting, by a smart shelf of the virtual endless aisle, an event;
based on the event, transmitting, by the store hub to a display screen visible to the user, information concerning the product;
displaying, by the display screen, a portion of the virtual endless aisle that includes the information concerning the product;
detecting, by a camera associated with the virtual endless aisle, a product selection signal generated by the customer; and
enabling, by the virtual endless aisle, the customer to purchase the product.

2. The method as recited in claim 1, wherein the product selection signal comprises a gesture by the customer that is detected by the camera.

3. The method as recited in claim 1, wherein the interaction is physical.

4. The method as recited in claim 1, wherein the interaction is virtual.

5. The method as recited in claim 1, wherein the display screen is one of a group of display screens visible to the customer, and the displaying of the information on the display screen is based on detection of a pupil of an eye of the customer.

6. The method as recited in claim 1, wherein a presence, and a location, of the customer in a physical space associated with the virtual endless aisle are determined using the camera and a radio beacon.

7. The method as recited in claim 6, wherein the radio beacon determines the location of the customer based on a signal received from the mobile device of the customer.

8. The method as recited in claim 1, wherein the enabling of the customer to purchase the product comprises presenting an ‘add to cart’ option to the customer on the app, providing checkout information to the customer by way of the app, and enabling the customer to checkout with the app.

9. The method as recited in claim 1, wherein the information concerning the product comprises model designs and stock availability, and/or a video.

10. The method as recited in claim 1, wherein after the interaction, a ‘try on’ option is presented to the user on the display screen.

11. A non-transitory storage medium having stored therein instructions that are executable by one or more hardware processors to perform operations comprising:
connecting an app on a mobile device of a customer to a store hub associated with a virtual endless aisle;
in response to an interaction of the customer with a product, emitting, by a smart shelf of the virtual endless aisle, an event;
based on the event, transmitting, by the store hub to a display screen visible to the user, information concerning the product;
displaying, by the display screen, a portion of the virtual endless aisle that includes the information concerning the product;
detecting, by a camera associated with the virtual endless aisle, a product selection signal generated by the customer; and
enabling, by the virtual endless aisle, the customer to purchase the product.

12. The non-transitory storage medium as recited in claim 11, wherein the product selection signal comprises a gesture by the customer that is detected by the camera.

13. The non-transitory storage medium as recited in claim 11, wherein the interaction is physical.

14. The non-transitory storage medium as recited in claim 11, wherein the interaction is virtual.

15. The non-transitory storage medium as recited in claim 11, wherein the display screen is one of a group of display screens visible to the customer, and the displaying of the information on the display screen is based on detection of a pupil of an eye of the customer.

16. The non-transitory storage medium as recited in claim 11, wherein a presence, and a location, of the customer in a physical space associated with the virtual endless aisle are determined using the camera and a radio beacon.

17. The non-transitory storage medium as recited in claim 16, wherein the radio beacon determines the location of the customer based on a signal received from the mobile device of the customer.

18. The non-transitory storage medium as recited in claim 11, wherein the enabling of the customer to purchase the product comprises presenting an ‘add to cart’ option to the customer on the app, providing checkout information to the customer by way of the app, and enabling the customer to checkout with the app.

19. The non-transitory storage medium as recited in claim 11, wherein the information concerning the product comprises model designs and stock availability, and/or a video.

20. The non-transitory storage medium as recited in claim 11, wherein after the interaction, a ‘try on’ option is presented to the user on the display screen.
